(19) United States
(12) Patent Application Publication
(10) Pub. No.: US 2020/0399952 A1
(43) Pub. Date: Dec. 24, 2020

(54) Assembly of a Box, in Particular a Roller Shutter Box, and Mounting Frame

(71) Applicant: Deceuninck NV, Hooglede-Gits (BE)

(72) Inventors: Luc Soetaert, Hooglede-Gits (BE); Florent Kimpe, Hooglede-Gits (BE); Bart Kyndt, Hooglede-Gits (BE)

(21) Appl. No.: 16/977,082

(22) PCT Filed: Mar. 20, 2019
(86) PCT No.: PCT/EP2019/056979

§ 371 Date: Aug. 31, 2020

(30) Foreign Application Priority Data
Mar. 21, 2018 (EP) 18163050.0

(51) Int. Cl. E06B 9/17

(52) U.S. Cl. CPC E06B 9/1703; E06B 2009/17069; E06B 9/17015

(57) ABSTRACT

An assembly of a box includes an outer wall defining an inner space and a mounting frame provided outside the box and defining an undercut section. A mounting mechanism is provided in the inner space, configured to fix the box on the mounting frame. The mounting mechanism has a clamp extending through an opening in the outer wall configured to engage with the undercut portion of the mounting frame. A lever coupled to the clamp by a hinge allows operation of the clamp between a clamping position and a non-clamping position. The lever is accessible from outside the box.

### FIELD OF THE INVENTION

The present invention relates to an assembly of a box, more particularly, a roller shutter box and a mounting frame for mounting and securing the box on top of a window frame or such.

### BACKGROUND

A roller shutter box is a multi-wall structure for encasing a roller shutter and its operating mechanism. As known, roller shutter boxes not only provide a housing for the roller shutter, it also serves as for insulating the architectural opening, typically between a window and lintel and to anchor the window frame, or eventually door frame, in view of the lintel.

To ensure good anchoring of the window frame, it is known from example given DE 202014101111 to provide stability anchors in the roller shutter box. Such anchors are typically made in metal comprise a top part configured to be securely fastened to the lintel; a bottom part configured to be securely fastened to the window frame and a vertical part connecting the top and bottom parts. The bottom and top parts can be provided either inside the space defined by the roller shutter box' outer wall or can extend through holes in said outer wall yet are always securely connected by screws or by plug and groove connection to respectively the window frame and the lintel. The vertical part typically extends in the space defined by the outer wall of the roller shutter box at a side of the box typically facing a room side of building wherein the roller shutter box is installed (ie. out of the way for rolling down the roller shutter).

To install a roller shutter box on a window frame, one needs to first position the roller shutter box on the window frame and subsequently open the roller shutter box outer wall to access bolts for fastening the anchor (and roller shutter box) to the window frame. Such opening of the roller shutter box implies removing any insulation present in the roller shutter box and subsequent refitting of the insulation and re-closing of the roller shutter box.

Furthermore, as anchors are provided at a predetermined distance from one another of approximately one meter, it is clear that a majority of the roller shutter boxes will comprise two or more anchors, which when installed are positioned in between the roller shutter and the inside of a building wherein the roller shutter box is mounted, such that removing the roller shutter from the roller shutter box for maintenance or repair becomes impossible without removing the anchor(s). Removing the anchors, however, also implies unfastening the roller shutter box from the window frame or, at the very least, removing the tension applied on the roller shutter box towards the window frame and thereby disrupting any sealing between the window frame and the outer wall of the roller shutter box.

It is clear from the above that there remains a market need for roller shutter boxes which are easy to install and which allow guaranteeing a good insulation between the roller shutter box and a window frame (or door frame) whereon the roller shutter box is installed, even after removal and re-installment of the roller shutter accommodated in the roller shutter of maintenance or replacement.

### SUMMARY OF THE INVENTION

The present invention addresses this market need and provides for an assembly of a box comprising an outer wall defining an inner space, and a mounting frame provided outside said box and defining an undercut section, wherein a mounting mechanism is provided in said inner space, which mounting frame is configured to fix the box on the mounting frame, characterized in that said mounting mechanism comprises:
a clamp extending through an opening in said outer wall configured to engage with said undercut portion of the mounting frame; and
a lever coupled to said clamp by a hinge allowing operating the clamp between a clamping position and a non-clamping position, said lever being accessible from outside the box.

### DETAILED SUMMARY OF THE INVENTION

The assembly preferably comprises an actuating member for moving the lever from a non-clamping position to a clamping position.

In a preferred embodiment, the actuating member is on the one hand fixed to the mounting frame and, on the other hand fixed to the lever and wherein the actuating member allows varying the distance between the mounting frame and the lever, thereby shifting the lever between a non-clamping position and a clamping position or vice-versa.

The actuating member may for example, be a screw or bolt.

According to a preferred embodiment, the roller shutter box comprises one or more stability anchors extending predominantly perpendicular to the mounting frame between a side of the box facing the mounting frame and an opposite side of the box.

The stability anchor preferably comprises a foot portion, whereas the mounting mechanism preferably comprises a base defining a slot and supporting the hinge of the mounting mechanism, the foot portion of the stability anchor being rigidly fixed to said base.

The outer wall and the mounting frame may comprise mutually cooperating snap fits, allowing positioning and fitting the box on the mounting frame in a position wherein the clamp can engage with the undercut.

Said box is preferably intended to be installed in an architectural opening in a building, whereby, in said outer wall of the box, a longitudinal slit is defined, said longitudinal slit is positioned at an outer wall part of the box configured to face outward of a building wherein the box is installed and the box further comprising an insulation member extending parallel to said longitudinal slit and positioned at an outer wall part of the box configured to face a window or wall part of the building wherein the box is installed, the insulation member defining a boundary between a cold zone of the box facing the outside of the building and a warm zone facing the inside of the building, whereby the opening in the outer wall wherethrough the clamp of the mounting mechanism extends is situated in the cold zone of the box.

The undercut in the mounting frame, with the box clamped thereon is preferably positioned closer to the insulation member than to said longitudinal slit, thus applying force on the insulating member and compressing it between the box and the building for good insulation.

The one or more stability anchors are preferably comprised of at least two parts, a bottom part and a top part, the bottom part comprising the foot portion and the top part comprising a top connection portion configured to connect the anchor to a part of a building wherein the box is installed facing the said opposed side of the box, wherein the bottom part and top part of the stability anchor are rigidly fixed to one another such as to prevent varying the distance between the foot portion and the top connection portion.

The top and bottom parts of the stability anchor are preferably releasably fixed to one another.

The assembly further preferably provides for the top connection portion comprising plugs or bolts extending through the outer wall of the box at said opposed side wall of the box and cooperate with an auxiliary piece positioned outside the box and configured to be rigidly fixed to a building wherein the box is installed. Optionally distance holders can be provided around or next to the plugs or bolts in the outer wall of the box, said distance holders having a compression resistance superior to the compression resistance of the outer wall of the box in a longitudinal direction perpendicular to the wall part of the box at the position of the plugs or bolts. The box is preferably intended to be installed in an architectural opening in a building, wherein, in said outer wall of the box, a longitudinal slit is defined, said longitudinal slit is positioned at an outer wall part of the box configured to face outward of a building wherein the box is installed and the box further comprising an insulation member extending parallel to said longitudinal slit and positioned at an outer wall part of the box configured to face a window or wall part of the building wherein the box is installed, the insulation member defining a boundary between a cold zone of the box facing the outside of the building and a warm zone facing the inside of the building, whereby the position at which the bolts or plugs extend through the outer wall of the box, is situated in the cold zone of the box.

The box is preferably a roller shutter box or a roller blind box, housing a roller shutter or roller blind and defining a longitudinal slit in its outer wall where through the roller shutter or roller blind can be rolled out or in of the box.

### BRIEF DESCRIPTION OF THE DRAWINGS

The following drawings illustrates exemplary embodiment; however, they are helpful in illustrating objects, features and advantages of the present invention. The present invention will be more apparent from the following detailed description taken in conjunction with accompanying drawings in which:

FIG. 1 illustrates the perspective view of window frame with a roller shutter box mounted thereon.

FIG. 2 illustrates the cross-sectional view of a box from an assembly according to the present invention.

FIG. 3 illustrates the exploded view of the lever clamp of the present invention.

FIG. 4 illustrates the perspective view of the stability anchor that can optionally be provided in an assembly of the present invention.

FIG. 5 illustrates the front view of the present invention when the box is yet to be installed on the mounting frame.

FIG. 6 illustrates the front view of the present invention when the box is installed on the mounting frame.

FIG. 7 illustrates the closer view of the present invention when the box is installed on the mounting frame, yet prior to clamping of the box on the mounting frame.

FIG. 8 illustrates the front view of the present invention illustrating the clamp in a clamped position.

FIG. 9 illustrates the top portion of the stability anchor receiving two screws from the holes on the top side of the box.

FIG. 10 illustrates the top portion of the stability anchor receiving two plugs from the holes on the top side of the box.

FIG. 11 illustrates the auxiliary profile where the bolts or plugs are rigidly connected.

FIG. 12 illustrates coupling of the top side of the box with the edge of a lintel.

FIG. 13 illustrates yet another way of coupling of the top side of the box with a lintel.

### DETAILED DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present invention relates to an assembly of a box and a mounting frame. The box, preferably a roller shutter box, comprises an outer wall that in this case comprises multiple walls part, preferably four, that together define an inner space of the box and which is configured to be coupled to a mounting frame by a clamp and lever mechanism. The clamp herein is coupled to a lever by a hinge wherein, the lever enables the clamp to operate between clamping position to non-clamping position and visa-versa.

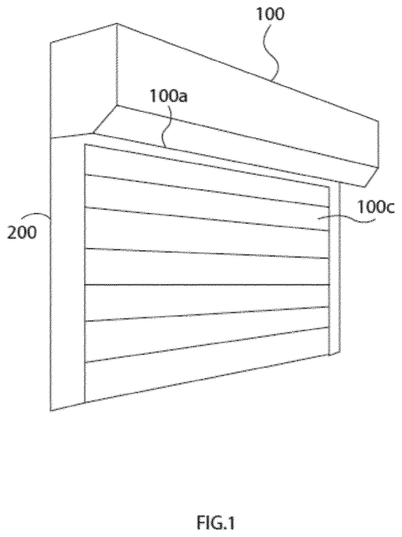

FIG. 1 illustrates the perspective view of the present invention wherein, the box, preferably, the roller shutter box (100) is installed in an architectural opening (200) in a building between a window frame and the masonry. The roller shutter box is hereto rigidly fixed to the window frame by intermediate of a mounting frame (not shown). The roller shutter box (100) comprises at least an outer wall (100a), in this case comprised of four walls sections defining an inner space within the roller shutter box, wherein the roller shutter is suspended and optionally driving means for rolling the roller shutter up and down, are housed.

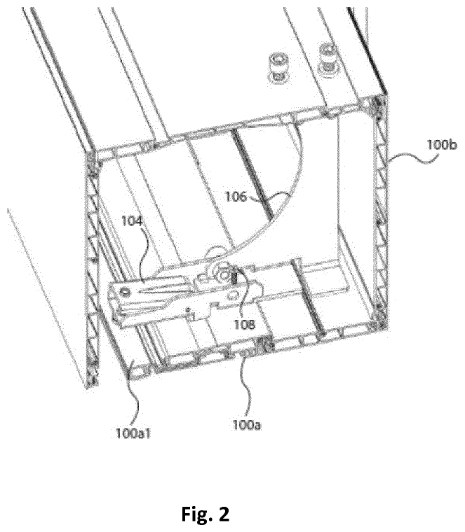

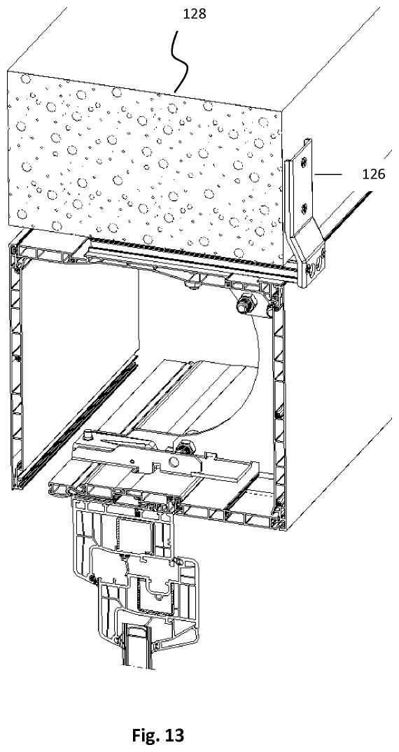

FIG. 2 illustrates the top perspective, cross-sectional view of the roller shutter box of an assembly according to a preferred embodiment of the present invention. In this cross-sectional view is shown that the outer wall (100a) defines a longitudinal slit opening allowing passage to the roller shutter (100c) or blind. Inside the box and in accordance with the present invention, a mounting mechanism is provided comprising a clamp extending through an opening in said outer wall and configured to engage with an undercut portion of the mounting frame; and a lever coupled to said clamp by a hinge allowing operating the clamp between a clamping position and a non-clamping position, said lever being accessible from outside the box. The mounting mechanism preferably comprises a base supporting said hinge. In this case, the base of the mounting mechanism defines a slot for receiving and accommodating a foot portion of a stability anchor provided in the roller shutter box and rigidly connecting two opposite structures in between which the architectural opening in the building is defined. As shown in FIG. 13, these structure in this case are a window frame (on the lower side) and a lintel (on the upper side).

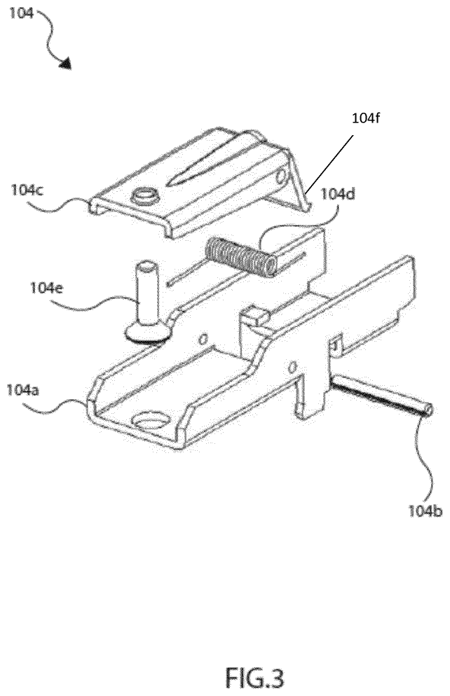

FIG. 3 illustrates the perspective view of the mounting mechanism (104) of present invention comprising a base (104a), a hinge (axis 104b+spring 104d) and a lever (104c). The base (104a) is enabled to be coupled to the inner space of the outer wall (not shown) by a screw or bolt and a hinge (axis 104b+spring 104d). Herein, the lever (104c) extend through the opening of the outer wall and couple to the undercut section of the mounting frame (not shown). The actuating member (104e) which is a bolt or a screw enables lever (104c) to be operated between a clamping position and a non-clamping position or vice-versa.

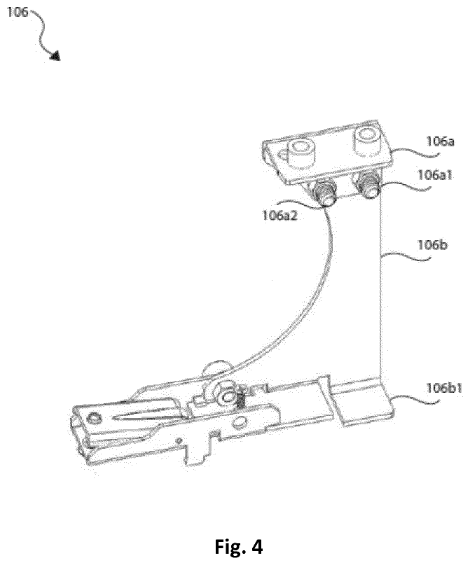

The stability anchor(s) (106), one of which stability anchors is shown in the FIG. 2 and which are shown in more detail in FIG. 4, are preferably made in several parts, namely, a bottom part and a top part, the bottom part comprising the foot portion accommodated in the base of the mounting mechanism (and fixed herein by means of a screw or bolt) and the top part comprising a top connection portion configured to connect the anchor to a part of a building wherein the box is installed facing an opposed side of the box, wherein the bottom part and top part of the stability anchor are rigidly, and preferably releasably, fixed to one another such as to prevent varying the distance between the foot portion and the top connection portion. The stability anchor (106) provided in the box predominantly extends in a direction perpendicular to the mounting frame (not shown) over the entire height of the box and connecting both building structures defining the architectural opening wherein the box is mounted.

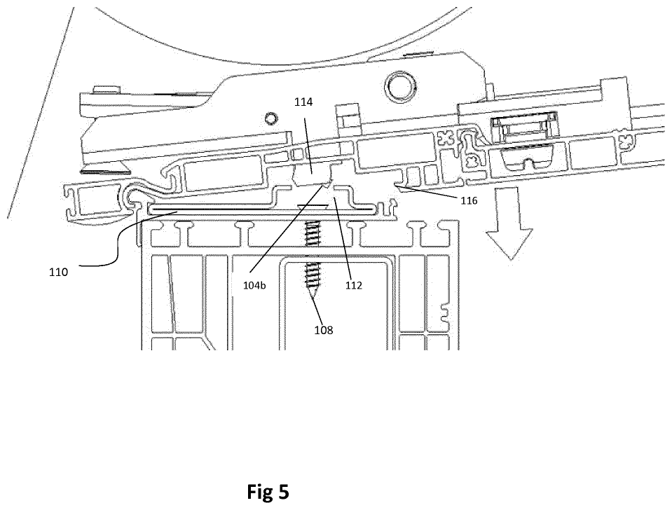

FIG. 5 illustrates a detailed front view of the mounting mechanism the box and its cooperation with the mounting profile, in a situation wherein the box is to be positioned on a window frame, in particular a polymeric window frame comprising a reinforcement profile in one of its inner cavities. As shown, the mounting frame is fixed to the window profile by a plurality of screws (one of which is shown) extending through the mounting frame and into the reinforcement profile of the window frame. The mounting frame (110) defines an undercut section (112) to receive the receive the extension of the lever 104c forming the clamp. The mounting frame and the corresponding outer wall of the box comprise cooperating snap fits (114) & (116) wherein allowing positioning and coupling the box on the mounting frame (110).

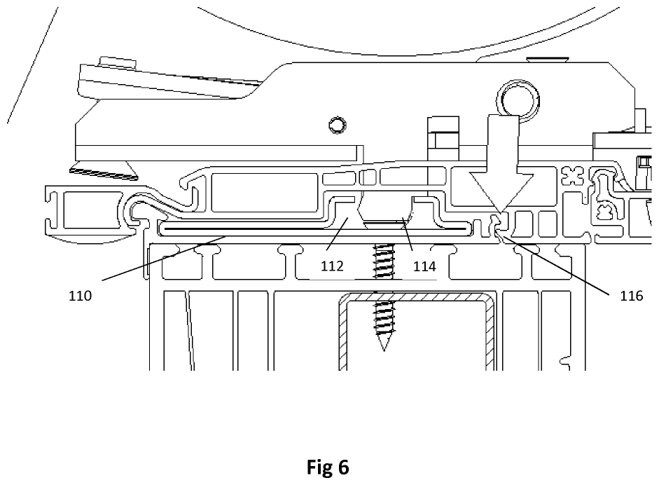

FIG. 6 illustrates the same detailed front view as FIG. 5, yet after correct positioning of the box on the mounting frame. The snap fits (114) & (116) in this case interlocked with one another and the box rests on the mounting frame (110). It is further shown that the lever and clamp (is in a non-clamped position.

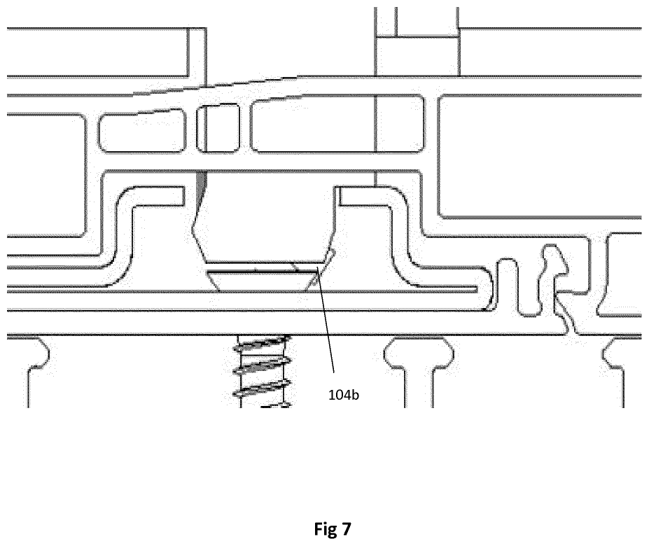

FIG. 7 illustrates an even more detailed view of FIG. 6 with the lever and clamp (104c) in a non-clamped position.

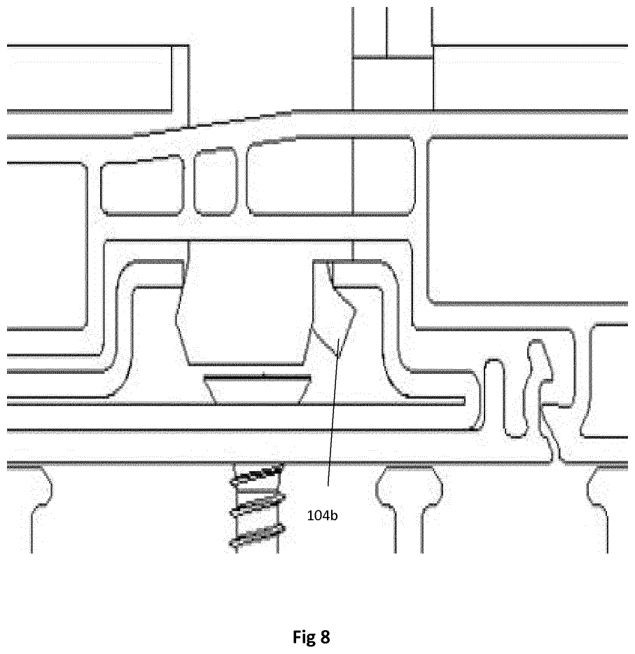

FIG. 8 illustrates the front view of the present invention illustrating the clamp (104c) in a clamped position. The clamping is achieved by pressing or pulling down the lever, which is preferably obtained by actuating an actuating member that on the one hand fixed to the mounting frame and, on the other hand fixed to the lever and wherein the actuating member allows varying the distance between the mounting frame and the lever, thereby shifting the lever between a non-clamping position and a clamping position or vice-versa. In this case the actuating member is a screw or bolt.

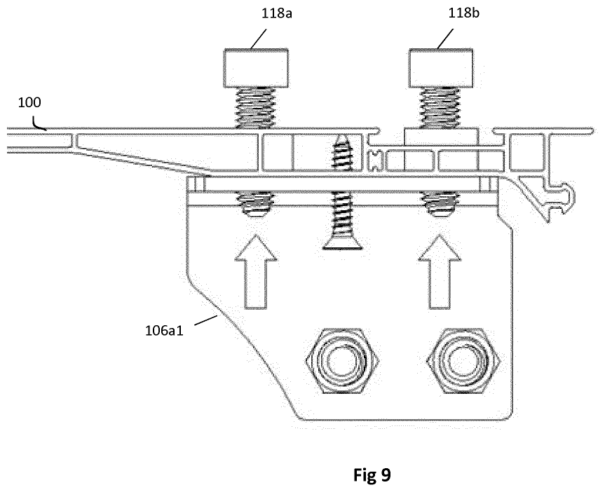

FIG. 9 illustrates an embodiment of the present invention illustrating the top portion of the stability anchor (106a1) receiving two screws (118a, 118b) from the holes (not shown) on the top side of the box. The embodiment illustrates fixation of the box (100), preferably the roller shutter box, to a lintel without opening it. As shown, two bolts are coupled to the top side of the stability anchor (106a1) through the holes (not shown) on the top wall of the box (100).

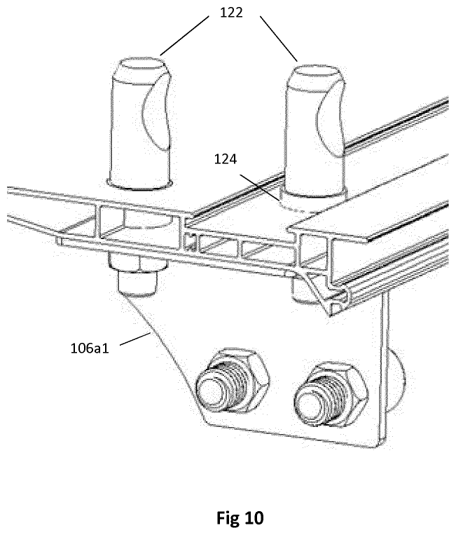

FIG. 10 illustrates a yet another embodiment of the present invention where two plugs (122), each having a broad top end, are provided extending through the ring-shaped distance holders (124) and into holes in the top part of the static anchor (106a1).

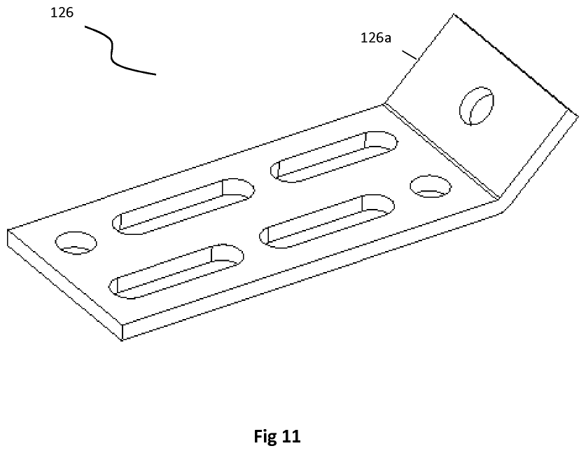

FIG. 11 illustrates an auxiliary profile (126) where the bolts or plugs are enabled to rigidly connect to and is subsequently attached to the lintel (not shown). For attachment to the lintel, a slanting part (126a) or upstanding rim is provided on the auxiliary piece (126), allowing access to the hole therein for screwing/bolting the piece to the lintel (not shown). It is clear that by applying such connection between the stability anchor and the lintel, the fixation of the anchor to the masonry or lintel can be achieved without opening the box.

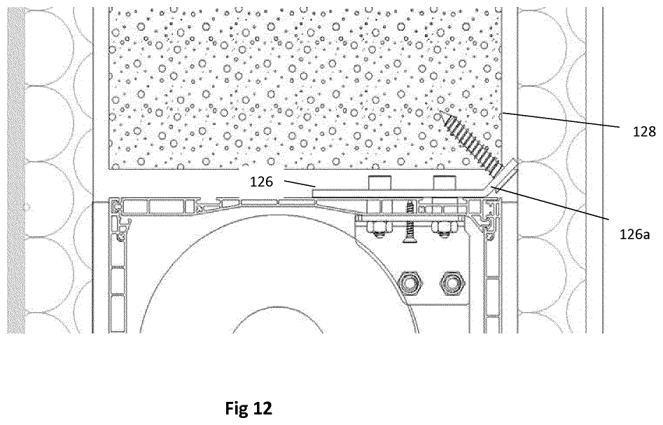

FIG. 12 illustrates coupling of the top side of the box, preferably the roller shutter box, with the edge of lintel (128) by a screw through the slanting part (126a) of the auxiliary profile (126). Again, it is clear that by applying such connection between the stability anchor and the lintel, the fixation of the anchor to the masonry or lintel can be achieved without opening the box.

FIG. 13 illustrates yet another embodiment where the coupling of the top side of the box, preferably the roller shutter box, with the lintel (128) by multiple screws of the auxiliary profile (126). Yet again, opening of the box is not required for fixing the anchor to the masonry or lintel.

In a preferred embodiment of the invention, the box (100), preferably the roller shutter box, comprises an outer wall (100a) defining an inner space (100a1) and a mounting frame (110). The mounting frame is rigidly coupled to the window frame profile (200) and further comprises an undercut section (112). Also, the outer wall (100a) comprises at least one hole (100d) through which a clamp (104f) of the mounting mechanism (104) is configured to engage with the undercut section (112) of the mounting frame (110) to couple the outer wall (100a) of the box with the mounting frame (100). In an example, when the stability anchor (106) is coupled to the mounting mechanism (104) then the clamp is moved from non-clamping position to clamping position in the undercut section (112). Further, the lever (104c) of the present invention is accessible from the outside of the box (100) to enable installing and un-installing of the box (100) without opening the structure of the box. Moreover, one end of an actuating member (104e), such as bolt, is fixed on the mounting frame (110) and another end of the actuating member (104e) is fixed on the lever (104c) to allow varying the distance between the mounting frame (110) and the lever (104c). This accessibility allowing the shifting of the lever (104c) between the non-clamping position and the clamping position. Also, the stability anchor (106) is rigidly coupled to the outer wall (100a) of the box (100), preferably the roller shutter box, and is configured to engage with a base (104a) of the mounting mechanism (104). The foot portion or bottom portion (106a1) of the stability anchor (106) is configured to engage with the at least one slot (104a1) in the base (104a) of the mounting mechanism (104). Moreover, the outer wall (100a) and the mounting frame (110) comprises snap fits, allowing positioning and fitting the box (100) on the architectural opening (200) in the building in a suitable position wherein the clamp (104f) can engage with the undercut section (112). The outer wall (100a) of the box (100) further comprises opening (100d), preferably a longitudinal slit (100d) to face outward of the building. The box further comprises an insulation member (not shown) extending parallel to the longitudinal slit (100d) and positioned at the outer wall (100a) of the box configured to face a window or wall part of the building. The insulation member (not shown) defines a boundary between a cold zone of the box (100), facing the outside of the building and a warm zone facing the inside of the building. Further, the undercut section (112) in the mounting frame (110) is positioned close to the insulation member (not shown) than to the longitudinal slit (100d) resulting in good insulation between the box and building.

In yet another embodiment of the present invention, the stability anchor (106) is comprised of at least two portions, the bottom portion (106b) and the top portion (106a). The top portion (106a) comprises of plugs (122) or bolts (118a, 118b) extending through the top wall of the box. The auxiliary piece (126) is positioned outside the box and is configured to couple with the bolts (118a, 118b) or plugs (122) and is further configured to rigidly fix to the building with a slanted slide (126a) where the box (100) is installed. More specifically, the auxiliary piece (126) couple with the bolts (118a, 118b) or plugs (122) extending outwardly and the slanting side (126a) of the auxiliary piece (126) coupled with the lintel (128). Further, distance holders (124) are provided around or next to the plugs (122) or bolts (118a, 118b) in the outer wall of the box wherein the distance holders having a compression resistance superior to the compression resistance of the outer wall of the box in a longitudinal direction perpendicular to the wall part of the box.

It is clear that the assembly of box and mounting frame in accordance with the present invention allows for some important benefits, such as mounting and rigidly fixing the box on a mounting frame without the need to open the box, thereby sparing the effort of removing example given, insulation provided in the box for fixing the box to the mounting frame. Additionally, the set up of a clamp receiving a foot portion of the stability anchor, allows for removing the anchor without unclamping the box from the mounting frame and hence without removing the pressure on a seal provided between the outer wall of the box and a structure (eg window frame) to which it is fixed. Additionally by providing stability anchors made of at least two releasably coupled parts, a bottom portion of the stability anchor can be removed from the box, without releasing the connection between the outer wall of the box and the mounting frame (lever-clamp connection) and without disrupting the connection between the top portion of the anchor and the masonry or lintel, as such preventing disrupting insulation between the outer wall of the box and the building.

1. An assembly of a roller shutter box comprises an outer wall defining an inner space and a mounting frame provided outside said roller shutter box and defining an undercut section, wherein a mounting mechanism is provided in said inner space, configured to fix the roller shutter box on the mounting frame, wherein said mounting mechanism comprises:
a clamp extending through an opening in said outer wall configured to engage with said undercut portion of the mounting frame; and
a lever coupled to said clamp by a hinge allowing operating the clamp between a clamping position and a non-clamping position, said lever being accessible from outside the roller shutter box.

2. The assembly according to claim 1, comprising an actuating member for moving the lever from a non-clamping position to a clamping position.

3. The assembly according to claim 2, wherein actuating member is on a one hand fixed to the mounting frame and, on the other hand fixed to the lever and wherein the actuating member allows varying the distance between the mounting frame and the lever, thereby shifting the lever between a non-clamping position and a clamping position or vice-versa.

4. The assembly cording to claim 3, wherein the actuating member is a screw or bolt.

5. The assembly according to claim 1, comprising one or more stability anchors provided in the roller shutter box and extending predominantly perpendicular to the mounting frame between a side of the roller shutter box facing the mounting frame and an opposite side of the roller shutter box.

6. The assembly according to claim 5, wherein the stability anchor comprises a foot portion and wherein the mounting mechanism comprises a base defining a slot and supporting the hinge of the mounting mechanism, the foot portion of the stability anchor being rigidly fixed to said base.

7. The assembly according to claim 1, wherein the outer wall and the mounting frame comprise mutually cooperating snap fits, allowing positioning and fitting the roller shutter box on the mounting frame in a position wherein the clamp can engage with the undercut.

8. The assembly according to claim 1, wherein said roller shutter box is intended to be installed in an architectural opening in a building and wherein, in said outer wall of the roller shutter box, a longitudinal slit is defined, said longitudinal slit is positioned at an outer wall part of the roller shutter box configured to face outward of a building wherein the roller shutter box is installed and the roller shutter box further comprising an insulation member extending parallel to said longitudinal slit and positioned at an outer wall part of the box configured to face a window or wall part of the building wherein the box is installed, the insulation member defining a boundary between a cold zone of the box facing the outside of the building and a warm zone facing the inside of the building, whereby the opening in the outer wall wherethrough the clamp of the mounting mechanism extends is situated in the cold zone of the box.

9. The assembly according to claim 8, wherein the undercut in the mounting frame, with the roller shutter box clamped thereon, is positioned closer to the insulation member than to said longitudinal slit.

10. The assembly according to claim 6, wherein the one or more stability anchors are comprised of at least two parts, a bottom part and a top part, the bottom part comprising the foot portion and the top part comprising a top connection portion configured to connect the anchor to a part of a building wherein the box is installed facing the said opposed side of the box, wherein the bottom part and top part of the stability anchor are rigidly fixed to one another such as to prevent varying the distance between the foot portion and the top connection portion.

11. The assembly according to claim 10, wherein the top and bottom part of the stability anchor are releasably fixed to one another.

12. The assembly according to claim 10, wherein the top connection portion comprises plugs or bolts extending through the outer wall of the roller shutter box at said opposed side wall of the roller shutter box and cooperate with an auxiliary piece positioned outside the box and configured to be rigidly fixed to a building wherein the box is installed.

13. The assembly according to claim 12, wherein distance holders are provided around or next to the plugs or bolts in the outer wall of the roller shutter box, said distance holders having a compression resistance superior to the compression resistance of the outer wall of the box in a longitudinal direction perpendicular to the wall part of the box at the position of the plugs or bolts.

14. The assembly according to claim 10, wherein said roller shutter box is intended to be installed in an architectural opening in a building and wherein, in said outer wall of the box, a longitudinal slit is defined, said longitudinal slit is positioned at an outer wall part of the box configured to face outward of a building wherein the roller shutter box is installed and the roller shutter box further comprising an insulation member extending parallel to said longitudinal slit and positioned at an outer wall part of the roller shutter box configured to face a window or wall part of the building wherein the roller shutter box is installed, the insulation member defining a boundary between a cold zone of the box facing the outside of the building and a warm zone facing the inside of the building, whereby the position at which the bolts or plugs extend through the outer wall of the box is situated in the cold zone of the roller shutter box.

15. The assembly according to claim 1, wherein said box is a roller shutter box or a roller blind box, housing a roller shutter or roller blind and defining a longitudinal slit in its outer wall wherethrough the roller shutter or roller blind can be rolled out or in of the box.

16. The assembly according to claim 4, comprising one or more stability anchors provided in the roller shutter box and extending predominantly perpendicular to the mounting frame between a side of the roller shutter box facing the mounting frame and an opposite side of the roller shutter box.

17. The assembly according to claim 16, wherein the stability anchor comprises a foot portion and wherein the mounting mechanism comprises a base defining a slot and supporting the hinge of the mounting mechanism, the foot portion of the stability anchor being rigidly fixed to said base.

18. The assembly according to claim 17, wherein the outer wall and the mounting frame comprise mutually cooperating snap fits allowing positioning and fitting the roller shutter box on the mounting frame m a position wherein the clamp can engage with the undercut.

19. The assembly according to claim 11, wherein the top connection portion comprises plugs or bolts extending through the outer wall of the roller shutter box at said opposed side wall of the roller shutter box and cooperate with an auxiliary piece positioned outside the box and configured to be rigidly fixed to a building wherein the box is installed.

20. The assembly according to claim 19, wherein distance holders are provided around or next to the plugs or bolts in the outer wall of the roller shutter box, said distance holders having a compression resistance superior to the compression resistance of the outer wall of the box in a longitudinal direction perpendicular to the wall part of the box at the position of the plugs or bolts.
